(19) United States
(12) Patent Application Publication
(10) Pub. No.: US 2006/0074754 A1
(43) Pub. Date: Apr. 6, 2006

(54) System and method of creating and managing digital content offers

(76) Inventors: Takeshi Toyohara, New York, NY (US); Mike Stanley, Atlanta, GA (US); Matthew Narrell, New York, NY (US); Russell Zack, New York, NY (US); Steve Salzinger, Scarsdale, NY (US); Jeff Sherwin, Brooklyn, NY (US); Jon Farb, New York, NY (US)

Correspondence Address: SOFER & HAROUN, L.L.P.;Suite 910, 317 Madison Avenue, New York, NY, 10017, US

(21) Appl. No.: 11/196,493

(22) Filed: Aug. 3, 2005

Related U.S. Application Data
(63) Continuation-in-part of application No. 10/946,900, filed on Sep. 22, 2004.
(60) Provisional application No. 60/667,883, filed on Apr. 2, 2005.

(51) Int. Cl. G07G 1/14

(52) U.S. Cl. 705/14

(57) ABSTRACT

A method for creating, managing and storing content offers includes accessing an offer catalogue management module by a content provider, where the content provider supplies a consumer with digital content assets. A collection of digital content assets are reviewed by the content provider, to select a digital content asset offering to the consumer. The availability of the selected digital content asset is determined and a rights layer is applied to the offering. A price scheme is attached to the selected digital content asset to the consumer such that the offer catalogue management module creates a digital content offer based on the selected digital content asset, the availability of the digital content asset, the rights layer of the digital content asset and the price scheme for the digital content asset.

### REFERENCE TO RELATED APPLICATIONS

This application is a continuation-in-part of U.S. patent application Ser. No. 10/946,900, filed on Sep. 22, 2004, and is also related to and claims the benefit of priority to U.S. patent application Ser. No. 11/027,574, filed on Dec. 30, 2004, and U.S. Provisional Patent Application No. 60/667,883, filed on Apr. 2, 2005, the entirety of which are incorporated herein by reference.

### FIELD OF THE INVENTION

The present invention relates to the field of digital content delivery. More specifically, the present invention relates to the process of creating, managing and distributing digital content offers and associated information.

### BACKGROUND OF INVENTION

The digital entertainment market has been experiencing a growth spurt that has been fueled by consumer demand for personalized media experiences regardless of time, location and context. To meet market demands, content owners, distributors and producers, (referred to here forth as media providers) have been faced with the challenge of providing flexible methods for customers to purchase and consume digital content while increasing the productivity and efficiency levels of their backend business processes. To keep up with changing consumer preferences, media providers need to be able to modify business rules quickly and be able to make content packages in their catalogue available at a variety of prices and consumption rights. It should be noted that consumption rights are rules that are enforceable through conditional access, digital rights management and price points.

However, managing the product catalog can be a difficult feat for media providers considering the sheer volume of product information that flows through a media provider's internal systems. Added to this challenge is the fact that such data is typically recorded in multiple applications, locations and formats; thereby making it more difficult to distribute targeted content and appropriately respond to consumer requests. When these complexities are coupled with a plethora of business information such as rights, pricing and location, the correlation of this data in a catalog is taxing as information increasingly becomes unmanageable.

### OBJECTS AND SUMMARY OF INVENTION

It is an object of the present invention to provide an enhanced Offer Catalogue Management module as a subset of a digital media processing, management and distribution system. The present invention looks to overcome the drawbacks associated with the prior art by giving media providers the ability to better manage complexities that are inherent in creating, selling and supporting content offers in the digital entertainment marketplace. To this end, it is an object of the present invention to provide an automated method for streamlining the offer delivery and content transaction execution processes. Specifically, this affects the process of creating, managing, and monitoring content offers. Further, it is an object of the invention to track each step of an offer's development from creation, approval, to when it's finally published and update asset status data as the file moves through its deployment cycle.

The Offer Catalogue Management module is designed to automate the workflow for editing, validating, scheduling and publishing offers to a variety of catalogs or programming guides. It enables end-users (media providers) the ability to quickly and easily offer new products and services to consumers of digital content. Further, it enables end-users to make available multiple offers across price points, regions, availability dates and usage rules. The present invention makes it possible to correlate offers directly to a single piece of content and change associated attributes on an as needed basis, thereby making it easier to manage frequently changing offers.

To this end, the present invention is directed to a method for creating, managing and storing content offers. The method includes accessing an offer catalogue management module by a content provider, where the content provider supplies a consumer with digital content assets. A collection of digital content assets are reviewed by the content provider, to select a digital content asset offering to the consumer. The availability of the selected digital content asset is determined and a rights layer is applied to the offering.

A price scheme is attached to the selected digital content asset to the consumer such that the offer catalogue management module creates a digital content offer based on the selected digital content asset, the availability of the digital content asset, the rights layer of the digital content asset and the price scheme for the digital content asset.

### BRIEF DESCRIPTION OF DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings:

FIG. 1 is a high-level block diagram of a media production & distribution system, in accordance with one embodiment of the present invention;

FIG. 2 is a block diagram illustrating the elements of a digital product offer, in accordance with one embodiment of the present invention;

FIG. 3 is a flow chart of the process of creating and modifying an offer as in FIG. 2, in accordance with one embodiment of the present invention illustrating the offer creation and modification process; and

FIG. 4 illustrates the sample fields from a single purchase offer, in accordance with one embodiment of the present invention; and

FIG. 5 illustrates the offer workflow states.

### DESCRIPTION OF TERMS

The following terms are provided to establish an understanding of the invention:

1. Media Provider: content owner, distributing or reselling digital content, such as cable, wireless or broadband provider.

2. Customer: consumer of digital goods and services.

3. End-user: person using an application, system or method. For the purpose of this invention, the terms end-user and media provider are used interchangeably.

4. CableLabs™: a standard or format (founded in 1988 by members of the cable television industry) used in the distribution of content assets.

5. XML: Extensible Markup Language—a flexible way to create common information formats and share both the format and the data on the Internet, intranets, in digital cable infrastructure and elsewhere.

6. EPG: Electronic Program Guide—an onscreen guide that helps make it easier for viewers to choose, view and/or pay for the large number of channels, VOD (video on demand) programs, pay per view events, and shows available (particularly in a digital environment).

7. MSO: Multiple System Operators—a cable television company with more than one network is an example of an MSO.

8. VOD: Video On Demand—also referred to as on-demand programming, live-streaming, Internet-on-demand video or IP-based video, in addition to a number of other terms. The service enables e.g. television viewers to select a program and have it sent to them via a network such as a cable or satellite TV network.

9. DRM: Digital Rights Management—security-based technologies that enable a content owner to have control over how their content is distributed.

10. Package: for the purpose of this invention, a package pertains to an image, metadata, and video (or any other type of digital media) file all wrapped up into a final distribution format.

11. Local cache: a place to store something temporarily, for example, when returning to a page recently visited, the browser can obtain the Web site address from the cache rather than from the original server, thus saving the end-user time and the network, the burden of additional traffic.

12. WMA: Windows Media Audio—is a proprietary compressed audio file format developed by Microsoft. It supports digital rights management using a combination of elliptic curve cryptography key exchange, DES block cipher, a custom block cipher, RC4 stream cipher and the SHA-1 hashing function.

13. WMV: Windows Media Video—is a generic name for the set of proprietary streaming video technologies developed by Microsoft. It is part of the Windows Media framework. The video stream is often combined with an audio stream using WMA.

14. Real: technology developed by Real Networks, referring to a streaming media format with multiple bandwidths that makes it possible to distribute to a wider audience. The file passes through the consumer's player and is not saved to their hard drive.

### DETAILED DESCRIPTION OF INVENTION

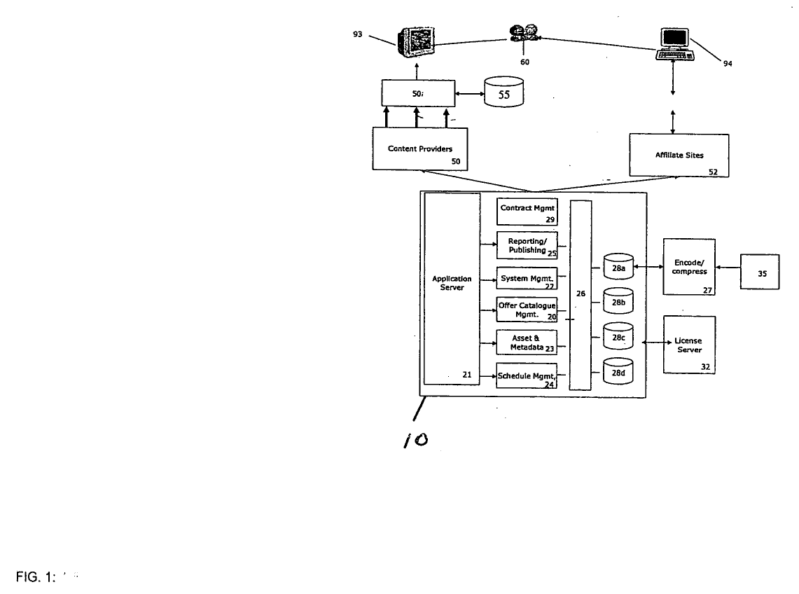

The present invention as described herein is a multi-module application that facilitates the processing, management and distribution of digital content. This system, (processing, management and distribution system) is represented in FIG. 1 as System 10. System 10 is configured to automate and simplify the lifecycle of a digital media file from inception to deployment on behalf of content providers 50, and their affiliated partners 52. The digital content may be supplied to customers 60 for example, on a DSTB 93 or home computer 94.

As illustrated in FIG. 1, processing, management and distribution system 10 includes an application server 21 for interfacing with an Asset & Metadata Management module 23, Schedule Management module 24, Contract Management module 29, Reports Management and Publishing module 25, System Management module 22 and an Offer Catalogue Management module 20. Each of these modules are further coupled to a rules engine 26 that applies the rules created and managed by the modules of system 10 to distribute digital content.

Rules engine 26 is further coupled to database storages modules 28a-28d configured to store the necessary information for delivering digital content to customers 60. Database 28a is a schedule/rule database that may further be connected to external content storage 35 via an encoding/compressing module 27. Database 28b is preferably configured as a user/MSO database. Also, database 28c is preferably configured as an XML storage database. Further, database 28d is configured as a metadata database. In one embodiment of the invention, content assets may be spread among different databases, including system database 28a and a distributor or MSO content database 55. System 10 may further be coupled to a License Server module 32 for handling additional digital content licensing process.

Although these databases 28a-28d and other associated modules are described as separate modules, this is only to clearly illustrate different functionality. It is assumed that any arrangement of such data within storage modules, either within or outside of system 10 is also within the contemplation of the present invention.

Turning now to the main functional modules of processing, management and distribution system 10, Asset and Metadata Management module 23 manages multiple types of assets, including audio, video and images. It provides a multi-role, multi-permission, metadata management tool for the development of content assets. Additionally, Asset and Metadata Management module 23 provides end-users, such as content providers 50, with the ability to import and validate asset and metadata from pre-defined templates. This information may be added to, modified, deleted or archived.

Asset and Metadata Management module 23 is responsible for managing the workflow surrounding the development and approval of digital assets and associated metadata. Assets and associated metadata may be entered in system 10 either manually (via an admin interface) or via a predefined feed. The new data stream may be automatically recognized by system 10 (it can determine whether or not an asset is incoming or outgoing in the process) or the end-user/content provider 50 may manually select the specific offer or package to apply to it. In either case, the new asset file is transported to the content delivery system. As the digital asset goes through its lifecycle, system 10 acknowledges all steps in the work status and automatically updates the work order status. Additionally, end-users 50 may monitor, update and manage asset status information, including data on assets that have been archived or deleted. Once a change is made, it is preferably reflected immediately in the system.

In one embodiment of the present invention, Schedule Management module 24, illustrated in FIG. 1, allows for the scheduling of assets and tracks data associated with contract information. Schedule Management module 24 manages any and all objects that are schedulable including, contracts, encoding times, DRM wrappers and content offers. This module also manages the availability of attributes pertaining to when multiple types of schedulable objects or digital content should be made available to targeted geographic locations.

Schedule Management module 24 also provides a centralized view of asset information for all time periods and enables end-users/content providers 50 to assess which assets should be delivered live, which should be launched and which were previously scheduled. Varying hour clusters indicate different time periods in which an asset can be included in the programming of a service. This enhances flexibility as one channel can offer multiple assets simultaneously with different customer rights options, rather than in a linear fashion, as in traditional broadcast schedules.

The Contract Management module 29 handles agreements with media providers that outline the terms for distributing content. Contract Management module 29 enables media providers 50 to add, edit, archive and delete any data related to contracts. It includes functionality for managing, validating and packaging digital content that has been licensed by content providers 50 from 3rd party content providers/producers. Licensing and contract information that is collected may include (but is not limited to) royalty minimums, total licenses, total expired licenses, license start and end dates in addition to specified limitations on the distribution of content. Rules can be set to enable notifications to be sent when a license is near its expiration date. Scheduling and licensing information are interrelated in such a way that each time the schedule is edited, revenue figures are recalculated, thereby e.g. enabling media providers to calculate total revenue figures based on scheduled assets and asset usage data in licensing agreements.

Also illustrated in FIG. 1, Reports Management and Publishing module 25 allows end-users to create and generate reports based on stored asset information as well as to publish assets to distributors (e.g. MSOs). Reports preferably include data that may be relevant to all aspects of the digital asset management process such as the number of available assets, the status of an asset or a customer's usage history. Further, this module enables media providers 50 to build reports on any asset data or offer-related activities in the system. Reports Management module 25 supports both canned and custom reports.

In another embodiment of system 10, illustrated in FIG. 1, digital content can be automatically published once to multiple locations without manual editing. Transmission lists can be sent by content providers 50 to distribution partners (other media providers that they have a distribution relationship with) and/or data feeds can be exported to legacy systems, applications built on earlier technologies that have been inherited, for asset information synchronization purposes. Further, Publishing module 25 can send transmission commands, metadata information and/or encoded assets and deliver to a variety of external locations. Publishing module 25 can also submit offer related information to a variety of network elements in the media provider's network such as to a DRM Packager, License Server, Billing System and/or Content Server. This information may be exported in multiple formats, including Cable Labs™, XML, WMA, WMV and Real to external systems. Moreover, Publishing module 25 includes a DRM packaging process that ensures the security of content as the digital file, along with license information is transported.

System Management module 22 includes administrative tools that are offered via a series of Web forms. It enables employees of content provider 50 with the appropriate level permissions to manage rules surrounding services, roles and access privileges. In particular, it enables end-users/content providers 50 to change the status of a title, including the ability to archive, restore or delete them. Further, content providers 50 may conduct searches on assets or view archived assets. System Management module 22 also provides the ability to add, edit and remove users. Information such as a system user's name, role, identification and contact information may also be managed within this module.

In one embodiment of the present invention, processing, management and distribution system 10 includes Offer Catalogue Management module 20 that provides a rules-driven listing of available digital product offerings. Offer Catalogue Management module 20 facilitates the creation, management and distribution of content offers as explained in more detail below.

Offer data pertains to digital content that is made available by media providers 50. Once an offer has been created, it is made available to any asset or product that is purchasable. Media providers 50 have the option to modify, delete or archive these offers. Offers include data relevant to making purchase decisions such as availability, assets, rights and pricing features. This information may be saved and used as templates for future offers. Additionally, Offer Catalogue Management module 20 makes it possible to cross-relate existing offers directly to a single piece of content and change associated attributes (as discussed above: availability, assets, rights and pricing) as business needs warrant. Further, the ability to correlate these offers back to a specific piece of content makes it possible for media providers to determine the success rate of their offerings.

It is understood that the above described modules are considered exemplary for processing, management and distribution system 10 and are in no way intended to limit the scope of the present invention. Any similar system using similarly functioning modules arranged to achieve similar communications goals is within the contemplation of the present invention.

As described above, Offer Catalogue Management module 20 provides the mechanisms for creating and managing content offers in a variety of business models. An offer may include none, one or multiple rights and price matrices that may be edited, deleted or otherwise manipulated by end-users. Each offer has attributes that describe how it can be redeemed and what prequalification checks are required for sale. Specifically, an offer consists of an asset, a license (possibly free), a price and an offer availability window.

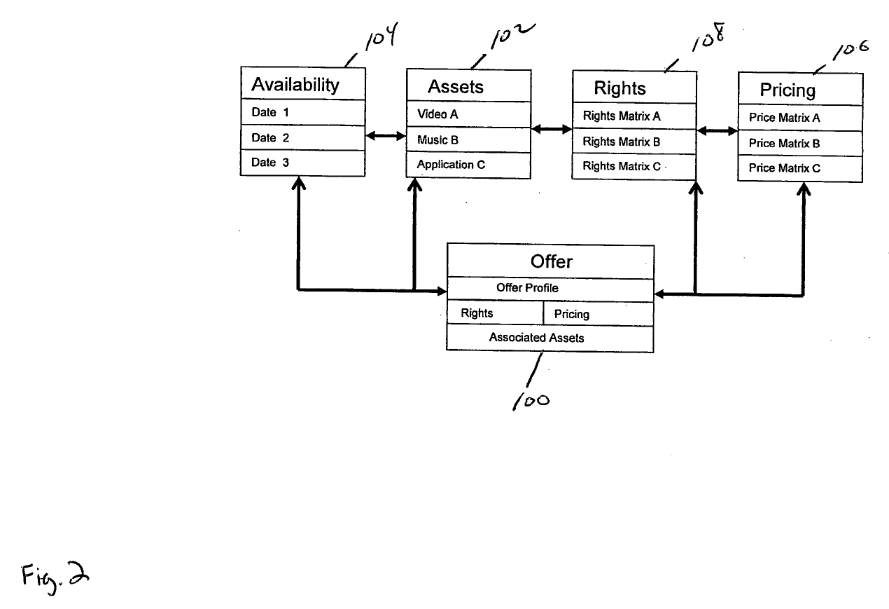

In one embodiment of the present invention, as illustrated in FIG. 2, the variables that make up an offer 100 are shown. By building rules around these variables, media providers/content providers 50 are able to govern how their content is used and consumed. For example, they may create limits on assets that are offered, configure bundled offerings, determine the order in which content is played, and/or provide consumers with the ability to transfer content to a selection of pre-authorized devices. This information may be modified to for example, target offerings to particular customers at certain locations. Moreover, consumed offerings (and their associated data) may be traced back to a particular content to assess the long-term salability of the offered content.

### Assets

As illustrated in FIG. 2, an offer 100 begins as a collection 102 of titles or assets, such as digital games, movies, music or other such digital content. For the purpose of this invention, a collection of assets is a group of one or more assets that are combined with relevant metadata (such as an asset's description). Assets and metadata are created and managed in the Asset and Metadata Management module 23 and System Management module 22, described above.

### Availability

Digital assets are made available within a particular scheduled window. A collection of assets may be locked according to a predetermined schedule or a rotating schedule list may be maintained within the package itself. Prior to setting the availability dates, media providers 50 may use the application's matching capabilities to target digital content to intended consumers or they may base content availability on attributes that are relevant to a subscription to a particular service for example, enabling a consumer to view Showtime On Demand™ because he/she has an existing subscription to Showtime Broadcast™. In either case, every offer requires an availability date; a table of availability dates 104 is attached to the offer via Schedule Management module 24.

### Price

Offer 100 contains data necessary for extracting revenue from content. In one embodiment of the present invention, end-users/content providers 50 can create or modify payment rules and attach them to content offerings or they may select from a variety of modifiable, prepackaged payment rules. Payment rules may be edited, saved or archived. Further, content provider 50 may exercise flexibility in setting up price structures 106 as illustrated in FIG. 2. Some offers 100 may for example, allow the digital content to be viewed during a given time period for a fixed price while others may impose restrictions such as limiting the overall number of times content can be played during a specific period of time. On the other hand, some may require consumer 50 to acquire a new license to view a video or allow him/her to view many videos for a flat fee. Offer Catalogue Management module 20 also supports multiple layers of price points within a given offer 100. Prices may be based on for example, content type, total cost of transaction, consumer's 60 rights and/or date of request. Moreover, it enables end-users/content providers 50 to offer multiple payment methods including credit card, cable bill and online payments.

In one embodiment of the present invention, Offer Catalogue Management module 20 supports a variety of business model templates that can handle a collection of assets 102 ranging from single point purchases to weekly subscriptions. Supported templates may include: one-time purchase of specific asset/digital content, one-time purchase of asset/digital content where the asset may be executed over a specific number of times, one-time purchase of asset/digital content where the asset may be executed during a specific period of time, one-time purchase of a set package of multiple assets. Further, it enables end-users/content providers 50 to provide offers 100 that may include details such as:

The option to order a title for a predetermined fee.

For one flat fee: unlimited access to order any title in the catalogue for 30 days.

For one flat fee: unlimited access to order all titles with DRM allowing a 24-hour shelf-life based on download completion time.

Free access: to a subset of titles, including previews of pay per view titles.

Free access: to a subset of titles if the customer subscribes to a related media service.

For one flat fee: unlimited access to order a subset of titles for 30 days.

For one flat fee: unlimited access to order a theme, genre or series package during a 24-hour period.

For one flat fee: subscription to a sequence of titles delivered 1 or 2 times a week for a set number of weeks.

The option to copy selected media to another device.

### Rights

Offer Catalogue Management module 20 further enables media providers 50 to employ multiple security and rights layers 108. Offer Catalogue Management module 20 supports both non-DRM and DRM-based businesses. In the case of the latter, all metadata required for encryption within a DRM system is handled by the present system. End-users/content providers 50 may add, modify, delete or archive rights data. This information may be used to for example, lock available titles so that only those who are entitled may access the desired digital content, end-users/content providers 50 may opt to provide those lacking appropriate access rights an alternate method of subscribing to or accessing desired content.

Rights data from rights listing 108 may be imported from DRM packages or may be selected from the following:

allowplay

playcount

allowcopy

copycount

allowbackup restore

allowplaylistburn

(maxplaylistburncount, playlistburntrackcount)

allow burn

delete on clock rollback

disable on clock rollback

output protection settings (optional as selected)
compressed digital audio
uncompressed digital audio
compressed digital video
uncompressed digital video
analog video
minimum security of player
selectable security level of what WMP (and DRM) is on device

revocation

grace period

begin date

expirationdate

expirationafterfirstuse

expiratioonstore

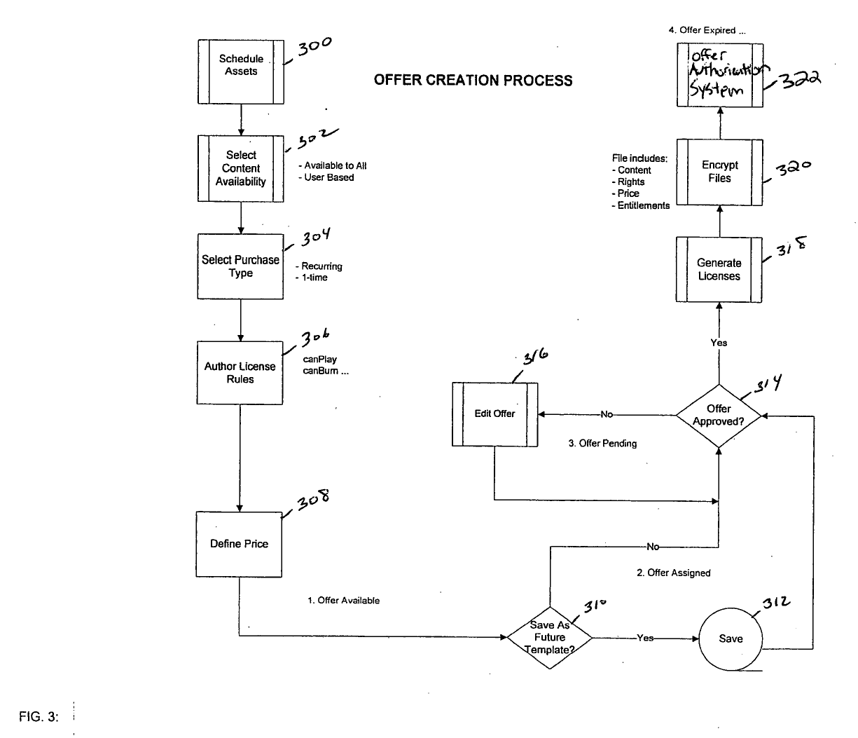

In one embodiment of the present invention, FIG. 3 is a flow chart of the process of creating and modifying an offer by Offer Catalogue Management module 20, such as offer 100 discussed above. As a first step, 300, content provider 50 schedules assets using Schedule Management module 24. This step entails setting up specific date and time intervals to publish assets. Next, at step 302, whether content should be made available to all users or to specific users is defined by content provider 50. Then at step 304, the purchase type is selected, content provider 50 may choose from either recurring purchases (subscription-based) or a 1-time purchase. At step 306, once assets are attached with availability data, content provider 50 selects from a collection of fields representing the flag structures for consumption rights (e.g. canPlay, canBurn).

As a next step, 308, the price for the offering is determined. At this point in time, content provider 50 is given the option to save the offer as a future template at step 310 or simply save at step 312. The offer is then either approved at step 314 or if further changes are required, the offer is edited at step 316. Upon approval, Offer Catalogue Management module 20 prepares to aggregate and publish the offer. The necessary licenses are generated at step 318, then the offer and associated data (content, rights, price and entitlements) are encrypted in step 320. Finally, after completing the offer, Offer Catalogue Management module 20 delivers the offer to an offer authorization system in step 322.

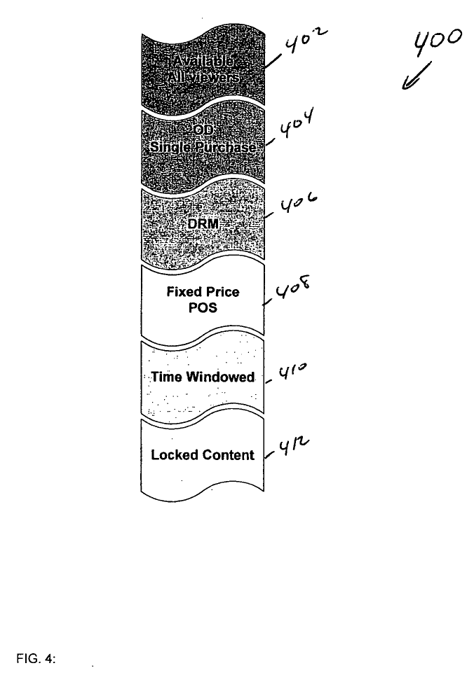

FIG. 4 provides an example of an offer 400 for a single title of a digital content that can be played within 24 hours of downloading; in this scenario, a standard price for all consumers is employed, the content is locked and nontransferable. As illustrated in FIG. 4, sample offer 400 maintains an availability field 402, order field 404, A DRM field 406, a price field 408, a time window field 410 and a content locked field 412.

The offer modification process, step 316, is similar to that of the offer creation process, as the same subsequent actions are triggered except instead of entering new offers; the existing data elements are updated. For example, when an offer is updated, Offer Catalogue Management module 20 triggers a series of events: licenses are generated (same as step 318) and stored, the files are encrypted (same as step 320) and uploaded to the distribution server, including entitlements, and then the file is made available for public consumption (same as step 322).

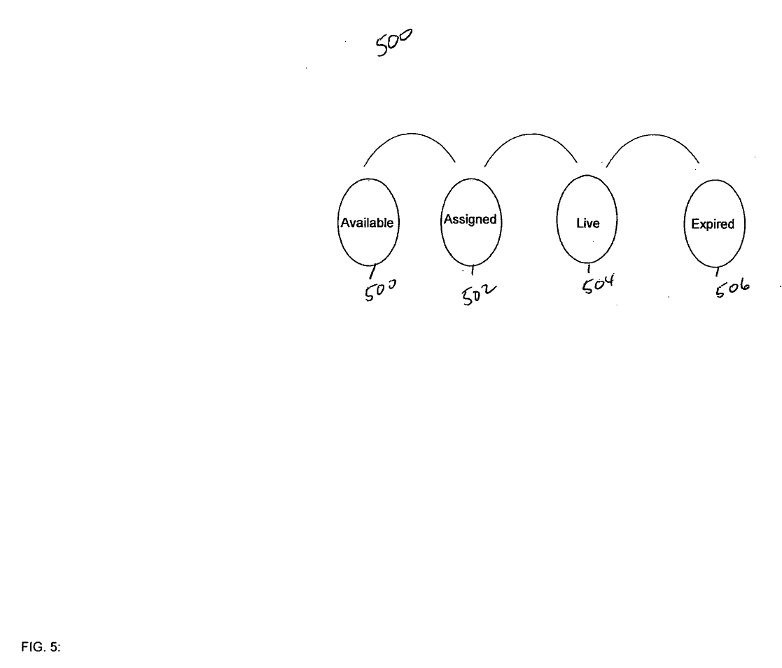

In one embodiment of the present invention, workflow states symbolize an offer's rate of progress as illustrated in FIG. 5. The first is the Available state 500 which refers to when a new product or digital asset is made available to customers, although it is not assigned to an offer (such as offer 100). Next, Assigned state 502, pertains to when a product or digital asset is assigned to an offer (such as offer 100) but is not available to customers 60. Additionally, Live state 504 describes a scenario where a product or digital asset is assigned to an offer, is live on system 10 and made available to customers 60. Finally, Expired state 506 refers to a state in which an offer (such as offer 100) is no longer live and/or available to customers 60. Offer Catalogue Management module 20 enables media providers to create, edit, duplicate or delete offer workflow states 500-506 illustrated in FIG. 5

Processing, management and distribution system 10 in its entirety, automates and simplifies the backend production and distribution of digital content and enables media providers 50 to manage the digital distribution process from the beginning to end. Offer Catalogue Management module 20 of system 10, allows media providers 50 to define, edit, archive or delete digital content offerings and associated data. Further, it enables the tracking of the lifecycle of digital offers and allows end-users/content providers 50 to manage and securely distribute targeted digital media offerings using a rules-based architecture.

Offer Catalogue Management module 20 provides built-in mechanisms for making available multiple offers, across price points, availability dates and usage rights; further, it simplifies the process of modifying these offers, thereby making it easier to manage high-volume content offers. Moreover, the ability to correlate existing offers directly to a single piece of content gives media providers a level of abstraction required to report on offers. As such, Offer Catalogue Management module 20 enables media providers to manage the complexities that are inherent in creating, selling and supporting content offers in today's digital entertainment market.

While only certain features of the invention have been illustrated and described herein, many modifications, substitutions, changes or equivalents may be created by those skilled in the art. It is therefore to be understood that this system and method is intended to cover all such modifications and changes that fall within the true spirit of the invention.

What is claimed is:

1. A method for creating, managing and storing content offers, said method comprising the steps of:
accessing an offer catalogue management module by a content provider, said content provider supplying a consumer with digital content assets;
reviewing a collection of digital content assets, by said content provider, to select a digital content asset offering to said consumer,
determining the availability of said selected digital content asset,
applying a rights layer to said offering, and
attaching a price scheme to said selected digital content asset to said consumer such that said offer catalogue management module creates a digital content offer based on said selected digital content asset, said availability of said digital content asset, said rights layer of said digital content asset and said price scheme for said digital content asset.

2. The method as claimed in claim 1, further including the step of said content provider modifying, deleting, tracking or archiving an offer at any time via said offer catalogue management module.

3. The method as claimed in claim 1, further comprising the step of supplying a workflow for the creation, approval and deployment of said offer.

4. The method as claimed in claim 3, further comprising the step of tracking a particular digital content asset during said workflow to update status of said digital content asset.

5. The method as claimed in claim 1, wherein the steps of applying a rights layer and generating a price scheme for the sale of said selected digital content asset in said offer includes a variety of distribution business models including but not limited to a point of purchase and weekly/monthly subscriptions.

6. The method as claimed in claim 1, further comprising the step of saving and storing an offer as a template for future offers.

7. The method as claimed in claim 1, wherein the collection of digital content assets, includes any one of digital games, digital movies, digital music and digital advertising.

8. The method as claimed in claim 1, wherein said step of said content provider creates a plurality of digital content offers including offers that differ across any one of price points, customer regions, availability dates, and usage rules.

9. The method as claimed in claim 1, wherein the availability of said selected digital content assets are set within a schedule window based on available dates for consuming said digital content asset.

10. The method as claimed in claim 1, wherein said step of determining the availability of said selected digital content asset includes either locking a selected digital content asset according to a predetermined schedule or to a rotating schedule list.

11. The method as claimed in claim 1, further comprising the step of applying a plurality of rights layers that may be attached to a digital content offering.

12. The method as claimed in claim 12, further comprising the step of creating, editing, saving, deleting or archiving said rights layers by said content provider.

13. The method as claimed in claim 1, wherein said step of applying a rights layer correlated to the consumer's rights to the selected digital content asset may include the import of a pre-set DRM (Digital Rights Management) package.

14. The method as claimed in claim 1, wherein said step of attaching a price scheme for the sale of said selected digital content asset entails data necessary for extracting revenue from content and prequalification checks required for sale of said content.

15. The method as claimed in claim 1, wherein said price scheme to said consumer comprises the step of creating, modifying, deleting and archiving payment rules of said offer by content provider.

16. The method as claimed in claim 1, wherein said price scheme to said consumer comprises the step of using and modifying prepackaged payment rules for creating said offer.

17. The method as claimed in claim 1, wherein said price scheme may be based on multiple layers of price points within a given offer including any one of digital content asset type, total cost of a transaction to purchase said offer, customer's rights conferred by said rights layer and said date of a request to accept the offer.

18. The method as claimed in claim 1, further comprising the step of said content provider correlating offers directly to a single piece of content.

19. The method as claimed in claim 16, further comprising the step of said content provider using said offer catalogue management module so as to obtain a report on the success rate of offer acceptances by said consumers.

20. A system for creating, managing and storing content offers, said system comprising:
an offer catalogue management module, said offer catalogue management module configured to interface with content providers so as to allow said content providers to:
review a collection of digital content assets and select a digital content asset to offer to a consumer,
determine the availability of said selected digital content asset,
apply a rights layer to the selected digital content asset, and
attach a price scheme to said selected digital content asset to said consumer such that said offer catalogue management module creates a digital content offer based on said selected digital content asset, said availability of said digital content asset, said rights layer of said digital content asset and said price scheme for said digital content asset.
